(19) United States
(12) Patent Application Publication
(10) Pub. No.: US 2017/0107746 A1
(43) Pub. Date: Apr. 20, 2017

(54) UNLOCKING METHOD AND SYSTEM FOR VEHICLE

(71) Applicant: Yulong Computer Telecommunication Scientific (Shenzhen) Co., Ltd., Shenzhen (CN)

(72) Inventors: Yan Liu, Shenzhen (CN); Yuqing Liu, Shenzhen (CN); Wei Sun, Shenzhen (CN)

(21) Appl. No.: 15/390,008

(22) Filed: Dec. 23, 2016

Related U.S. Application Data
(63) Continuation of application No. PCT/CN2015/078029, filed on Apr. 30, 2015.

(30) Foreign Application Priority Data
Jun. 27, 2014 (CN) 201410301296.0

(51) Int. Cl. E05B 81/76; B60R 25/24; B60R 25/01

(52) U.S. Cl. CPC E05B 81/76; B60R 25/01; B60R 25/24

(57) ABSTRACT

An unlocking method for a vehicle, comprising: electrically conducting a sending end to the human body; based on the contact between the human body and a vehicle body, establishing a connection between the sending end and the vehicle body through the human body; and sending, by the sending end, an unlocking instruction to unlock the vehicle body. Also provided is an unlocking system for a vehicle. The unlocking method is simple to operate, and has high user friendliness.

### CROSS-REFERENCE TO RELATED APPLICATION(S)

This application is a continuation of International Application No. PCT/CN2015/078029, filed on Apr. 30, 2015, which claims priority to Chinese Patent Application No.201410301296.0, filed on Jun. 27, 2014, the disclosure of both of which are herein incorporated by reference in their entireties.

### TECHNICAL FIELD

The present disclosure relates to the field of communication technology, and particularly to an unlocking method and system for a vehicle.

### BACKGROUND

There are several ways to unlock the door of a vehicle. For example, the vehicle can be unlocked by inserting a vehicle key into a keyhole and rotating the vehicle key. Another approach is remote unlocking, in which the vehicle key is provided with a remote control launcher configured to control locking and unlocking of the door of the vehicle. Both these approaches of unlocking have to unlock in advance and then pull the door handle, and the operation is complicated.

### SUMMARY

The present disclosure provides an unlocking method and system for a vehicle, through which the vehicle can be unlocked when people is in contact with the vehicle, and no pre-unlocking operation on the vehicle is required, so as to solve the problem that the existing vehicle door unlocking operation is complicated.

Technical schemes proposed in the present disclosure are as follows.

An unlocking method for a vehicle is provided in the present disclosure. The method includes: electrically conducting a sending end to a human body; based on the contact between the human body and a vehicle body, establishing a connection between the sending end and the vehicle body through the human body; and sending, by the sending end, an unlocking instruction to unlock the vehicle body.

Further, the contact between the human body and the vehicle body is the contact between the hand of the human body and the door handle of the vehicle body.

Further, the process of establishing the connection between the sending end and the vehicle body through the human body includes: providing a human body coupling module on the sending end and the vehicle body respectively; when the human body is in contact with the vehicle body, the human body coupling module provided in the sending end and the human body coupling module provided in the vehicle body are conducted through an electrical signal of the human body.

Further, before the process of establishing the connection between the sending end and the vehicle body, the method can further includes: performing, by the human body coupling module of the vehicle body, authentication judgment on the human body coupling module of the sending end.

Further, the process of sending, by the sending end, the unlocking instruction to unlock the vehicle body includes: sending the unlocking instruction to a vehicle door lock system of the vehicle body by the sending end; verifying the unlocking instruction by the vehicle door lock system of the vehicle body; if the verification is correct, unlocking the vehicle body by the vehicle door lock system of the vehicle body; if the verification is erroneous, not unlocking the vehicle body by the vehicle door lock system of the vehicle body.

An unlocking system for a vehicle is provided in the present disclosure. The system includes: a sending end, configured to send an unlocking instruction to unlock a vehicle body, among which the sending end is electrically conducted to a human body; based on the contact between the human body and the vehicle body, a connection is established between the sending end and the vehicle body through the human body.

Further, the contact between the human body and the vehicle body is the contact between the hand of the human body and the door handle of the vehicle body.

Further, the connection between the sending end and the vehicle body can be established through the human body as follows: a human body coupling module is provided in the sending end and the vehicle body respectively; when the human body is in contact with the vehicle body, the human body coupling module provided in the sending end and the human body coupling module provided in the vehicle body are conducted through an electrical signal of the human body.

Further, the human body coupling module of the vehicle body includes: an authentication module, configured to perform authentication judgment on the human body coupling module of the sending end before the connection is established between the sending end and the vehicle body.

Further, the vehicle body includes: a receiving end, configured to receive the unlocking instruction from the sending end; a verifying module, configured to verify the unlocking instruction; if the verification is correct, a vehicle door lock system of the vehicle body will unlock the vehicle body; if the verification is erroneous, the vehicle door lock system of the vehicle body will not unlock the vehicle body.

Through the above-mentioned technical schemes, the unlocking method and system for a vehicle of the present disclosure can have advantages that, when a human body is in contact with a vehicle body, a connection can be established between a sending end and the vehicle body through the human body which acts as a medium; after the connection is established, the sending end can send an unlocking instruction to the vehicle body by using the human body as a transmission path; the unlocking instruction will be sent to the vehicle body to unlock the vehicle body. The unlocking action and the door opening action are the same, and there is no need to separate the unlocking action and the opening action into two separate actions as in the related art. The unlocking mode of the present disclosure is easy to operate and can improve the user experience.

### BRIEF DESCRIPTION OF THE DRAWINGS

FIG. 1 is a flow chart illustrating an unlocking method for a vehicle according to an embodiment of the present disclosure;

FIG. 2 is a functional block diagram illustrating an unlocking system for a vehicle according to an embodiment of the present disclosure; and

FIG. 3 is a functional block diagram illustrating another unlocking system for a vehicle according to an embodiment of the present disclosure.

### DETAILED DESCRIPTION

To make the object, technical solutions, and beneficial effects of the present disclosure more apparent, the present disclosure will be described in detail with reference to the accompanying drawings and embodiments. It should be noted that, the embodiments described herein are for explanation only and not intended for restriction of the present disclosure.

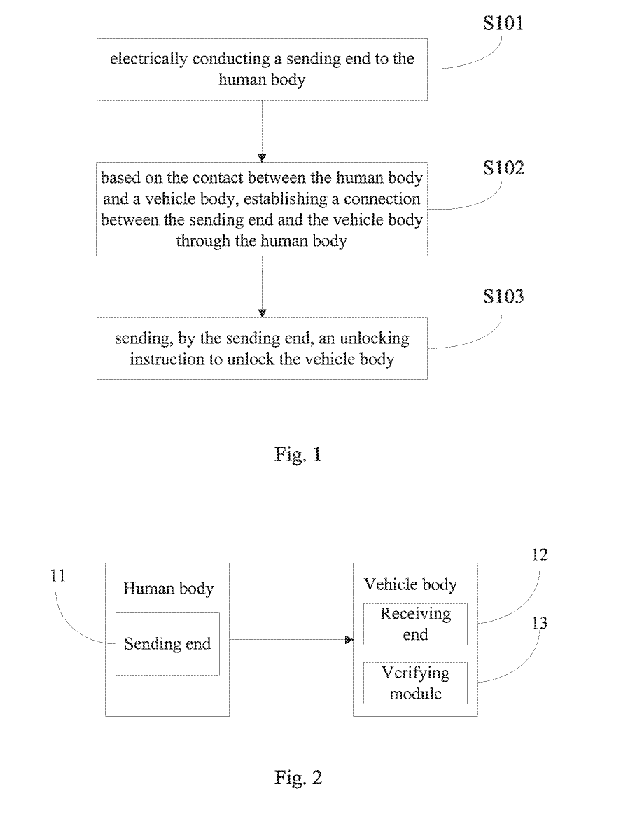

As illustrated in FIG. 1, the unlocking method for a vehicle according to an embodiment of the present disclosure can include the following steps.

S101, a sending end is electrically conducted to a human body.

The sending end is in contact with the skin of the human body, and therefore, the sending end can be electrically conducted to the human body.

Most wearable devices, such as watches and bracelets, can be in contact with the skin of the human body. For this reason, the sending end can be incorporated in a wearable device that in contact with the skin of the human body.

S102, based on the contact between the human body and a vehicle body, a connection is established between the sending end and the vehicle body through the human body.

When the human body is in contact with the vehicle body, the connection is established between the sending end carried by the human body and the vehicle body; and during the connection between the sending end and the vehicle body, the sending end carried by the human body is required to be in contact with the skin of the human body.

According to user habits of opening the door of a vehicle, the contact between the human body and the vehicle body can be the contact between the hand of the human body and the door handle of the vehicle body.

The medium for establishing the connection between the sending end and the vehicle body is the human body, and in this embodiment, human body coupling communication technology can be adopted. The human body coupling communication technology is to adjust the voltage of a transmitting circuit and monitor the potential difference of a receiver electrode so as to send signals; here, in addition to a potential difference in the human body, a small current will flow through the human body either. Transmission and reception of required data can be conducted with aid of bio-electricity of a biological (that is, human body) surface, and effective communication between the two parties can be achieved. Because the power of electrical signals transmitted through the human body is very low, it will not cause any harm to the human body. The human body coupling technology can use the capacitive character of the human body for signal transmission, and transfer information among equipment such as the human body and the like.

A human body coupling module is provided in the sending end and the vehicle body respectively, and the process of establishing the connection between the sending end and the vehicle body can include the follows: when the human body is in contact with the vehicle body, the human body coupling module of the sending end and the human body coupling module of the vehicle body can cause the sending end to be conducted to electrical signals of the vehicle body, so as to establish a communication connection.

The human body coupling module of the sending end can include a modulation circuit; the modulation circuit is connected with a first conductor, which is in contact with the skin of the human body and can transmit data by utilizing the capacitive character of the human body. The human body coupling module of the vehicle body can include a reception modulation circuit; the reception modulation circuit is connected with a second conductor, which is in contact with the skin of the human body and can detect a weak signal transmitted through the human body.

In this embodiment, the transmission of a signal is as follows: the sending end sends out a signal; after passing through the modulation circuit, the signal is transmitted to the human body by the first conductor; the signal can be transmitted through the human body and transferred to the vehicle body by using the human body as a medium, and through the second conductor, the vehicle body can receive the signal transmitted from the human body.

In this embodiment, the second conductor in the human body coupling module of the vehicle body is provided on an outer surface of the door handle of the vehicle body.

In this embodiment, before the communication connection between the sending end and the vehicle body is established, the human body coupling module of the vehicle body will perform authorization judgment on the human body coupling module of the sending end.

When the human body is in contact with the vehicle body, the human body coupling module of the vehicle body will distinguish the identity of the human body coupling module of the sending end. If the human body coupling module of the sending end has been authorized, the communication connection will be established between the sending end and the vehicle body; otherwise, if the human body coupling module of the sending end has not been authorized, the vehicle body will refuse to establish the communication connection with the sending end.

S103, the sending end sends an unlocking instruction to unlock the vehicle body.

After the connection between the sending end and the vehicle body is established, the sending end will send the unlocking instruction, and the vehicle body will be unlocked after the unlocking instruction sent from the sending end is received.

In this embodiment, S103 can include the follows. The sending end sends the unlocking instruction to a vehicle door lock system of the vehicle body; the vehicle door lock system of the vehicle body verifies the unlocking instruction; if the verification is correct, the vehicle door lock system of the vehicle body will unlock the vehicle body; if the verification is erroneous, the vehicle door lock system of the vehicle body will not unlock the vehicle body.

As can be seen, the vehicle door lock system of the vehicle body can verify the unlocking instruction of the sending end and unlock the vehicle body if the verification is successful.

To sum up, while the user pulls the door handle to open the door of the vehicle, the hand of the human body and the second conductor are in contact, the human body coupling module of the sending end (to be specific, through the first conductor) and the human body coupling module of the vehicle body (to be specific, through the second conductor) can cause the connection between the sending end and the vehicle body to be established by using the human body as a medium. The sending end can send the unlocking instruction to unlock the vehicle door lock system of the vehicle body, and the unlock action and the door opening action are the same action; therefore, the user can unlock and open the door of the vehicle at the same time, and the operation is more convenient.

In order to achieve the above-mentioned unlocking method for a vehicle, an unlocking system for a vehicle is provided. As illustrated in FIG. 2, the unlocking system for a vehicle according to an embodiment of the present disclosure can include a sending end 11.

The sending end 11 is configured to send an unlocking instruction to unlock a vehicle body. The sending end is electrically conducted to a human body; based on the contact between the human body and the vehicle body, a connection is established between the sending end 11 and the vehicle body through the human body.

The sending end 11 is further configured to be in contact with the skin of the human body; therefore, the sending end is conducted to electrical signals of the human body.

Most wearable devices, such as watches and bracelets, can be in contact with the skin of the human body. For this reason, the sending end 11 can be incorporated in a wearable device that in contact with the skin of the human body.

When the human body is in contact with the vehicle body, the connection is established between the sending end 11 carried by the human body and the vehicle body; and during the connection between the sending end 11 and the vehicle body, the sending end carried by the human body is required to be in contact with the skin of the human body.

According to user habits of opening the door of a vehicle, the contact between the human body and the vehicle body can be the contact between the hand of the human body and the door handle of the vehicle body.

The medium for establishing the connection between the sending end 11 and the vehicle body is the human body, and in this embodiment, human body coupling communication technology can be adopted. The human body coupling communication technology is to adjust the voltage of a transmitting circuit and monitor the potential difference of a receiver electrode so as to send signals; here, in addition to a potential difference in the human body, a small current will flow through the human body either. Transmission and reception of required data can be conducted with aid of bio-electricity of a biological (that is, the human body) surface, and effective communication between the two parties can be achieved. Because the power of electrical signals transmitted through the human body is very low, it will not cause any harm to the human body. The human body coupling technology can use the capacitive character of the human body for signal transmission, and transfer information among equipment such as the human body and the like.

A human body coupling module is provided in the sending end 11 and the vehicle body respectively, and the process of establishing the connection between the sending end 11 and the vehicle body can include the follows: when the human body is in contact with the vehicle body, the human body coupling module of the sending end 11 and the human body coupling module of the vehicle body can cause the sending end to be conducted to electrical signals of the vehicle body, so as to establish a communication connection.

The human body coupling module of the sending end 11 can include a modulation circuit; the modulation circuit is connected with a first conductor, which is in contact with the skin of the human body and can transmit data by utilizing the capacitive character of the human body. The human body coupling module of the vehicle body can include a reception modulation circuit; the reception modulation circuit is connected with a second conductor, which is in contact with the skin of the human body and can detect a weak signal transmitted through the human body.

In this embodiment, the transmission of a signal is as follows: the sending end sends out a signal; after passing through the modulation circuit, the signal is transmitted to the human body by the first conductor; the signal can be transmitted through the human body and transferred to the vehicle body by using the human body as a medium, and through the second conductor, the vehicle body can receive the signal transmitted from the human body.

In this embodiment, the second conductor in the human body coupling module of the vehicle body is provided on an outer surface of the door handle of the vehicle body.

In this embodiment, the human body coupling module of the vehicle body can includes: an authentication module, configured to perform authentication judgment on the human body coupling module of the sending end before the connection is established between the sending end and the vehicle body.

When the human body is in contact with the vehicle body, the human body coupling module of the vehicle body will distinguish the identity of the human body coupling module of the sending end 11. If the human body coupling module of the sending end 11 has been authorized, the communication connection will be established between the sending end 11 and the vehicle body; otherwise, if the human body coupling module of the sending end 11 has not been authorized, the vehicle body will refuse to establish the communication connection with the sending end.

The sending end 11 can send the unlocking instruction so as to unlock the vehicle body. After the connection between the sending end 11 and the vehicle body is established through the human body, the sending end 11 will send the unlocking instruction, and the vehicle body will receive the unlocking instruction sent by the sending end 11 to unlock the vehicle body.

In this embodiment, the vehicle body can include: a receiving end 12, configured to receive the unlocking instruction from the sending end 11; a verifying module 13, configured to verify the unlocking instruction; if the verification is correct, a vehicle door lock system of the vehicle body will unlock the vehicle body; if the verification is erroneous, the vehicle door lock system of the vehicle body will not unlock the vehicle body.

As can be seen, the verifying module 13 can verify the unlocking instruction of the sending end, and the vehicle door lock system of the vehicle body will unlock the vehicle body if the verification is successful.

To sum up, while the user pulls the door handle to open the door of the vehicle, the hand of the human body and the second conductor are in contact, the human body coupling module of the sending end 11 (to be specific, through the first conductor) and the human body coupling module of the vehicle body (to be specific, through the second conductor) can cause the connection between the sending end 11 and the vehicle body to be established by using the human body as a medium. The sending end 11 can send the unlocking instruction to unlock the vehicle door lock system of the vehicle body, and the unlock action and the door opening action are the same action; therefore, the user can unlock and open the door of the vehicle at the same time, and the operation is more convenient.

According to another embodiment of the present disclosure, it is provided an unlocking system for a vehicle. As an implementation, this unlocking system can be arranged in the vehicle body of the vehicle.

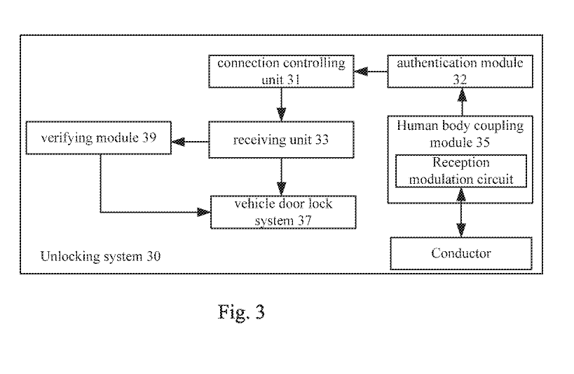

FIG. 3 is a block diagram illustrating the unlocking system according to the embodiment of the present disclosure. As shown in FIG. 3, the unlocking system 30 includes a connection controlling unit 31, a receiving unit 33, a human body coupling module 35, and a vehicle door lock system 37.

The connection controlling unit 31 is configured to establish a connection between the vehicle body and external equipment (such as the above-mentioned sending end) electrically conducted to a human body, wherein the human body is in contact with the vehicle body.

The receiving unit 33 is configured to receive an unlocking instruction sent from the external equipment.

The human body coupling module 35 is configured to be conducted to a human body coupling unit of the external equipment through electrical signals of the human body.

The vehicle door lock system 37 is configured to control the unlocking of the vehicle body.

As an implementation, the unlocking system can further include a verifying module 39, configured to verify the unlocking instruction. If the verification is correct, the vehicle door lock system 37 will unlock the vehicle body; if the verification is erroneous, the vehicle door lock system 37 will not unlock the vehicle body.

As another implementation, the unlocking system can further include an authentication module 32, configured to perform authentication judgment on the human body coupling module 35 of the external equipment before the connection is established between the external equipment and the vehicle body by the connection controlling unit 31.

The vehicle body can further include a door handle which is not illustrated in the figure, and the contact between the human body and the vehicle body can be the contact between the hand of the human body and the door handle of the vehicle body.

As an implementation, the human body coupling module 35 can include a reception modulation circuit connected with a conductor, and the conductor is configured to be in contact with the skin of the human body and detect signals transmitted through the human body.

The method and the functional units or modules of the system can be implemented through an apparatus equipped with at least one processor and a memory. The memory can be used to store program codes, when executed by the processor, the program codes are adapted to cause the processor to perform the steps or processor of the method or invoke the units of the system, so as to implement the technical scheme of the present disclosure. In order to avoid redundancy, details will not be repeated here and can be comprehended with reference to the above mentioned embodiments and the accompanying drawings.

While the present disclosure has been described in detail above with reference to the exemplary embodiments, the scope of the present disclosure is not limited thereto. As will occur to those skilled in the art, the present disclosure is susceptible to various modifications and changes without departing from the spirit and principle of the present disclosure. Therefore, the scope of the present disclosure should be determined by the scope of the claims.

What is claimed is:

1. A method for unlocking a vehicle, comprising:
electrically conducting a sending end to the human body;
based on the contact between the human body and a vehicle body, establishing a connection between the sending end and the vehicle body through the human body; and
sending, by the sending end, an unlocking instruction to unlock the vehicle body.

2. The method of claim 1, wherein the contact between the human body and the vehicle body is the contact between the hand of the human body and the door handle of the vehicle body.

3. The method of claim 1, wherein establishing the connection between the sending end and the vehicle body through the human body comprises:
providing a human body coupling module on the sending end and the vehicle body respectively, wherein when the human body is in contact with the vehicle body, the human body coupling module provided in the sending end and the human body coupling module provided in the vehicle body are conducted through an electrical signal of the human body.

4. The method of claim 3, wherein before establishing the connection between the sending end and the vehicle body, the method further comprising:
performing, by the human body coupling module of the vehicle body, authentication judgment on the human body coupling module of the sending end.

5. The method of claim 1, wherein sending, by the sending end, the unlocking instruction to unlock the vehicle body comprises:
sending the unlocking instruction to a vehicle door lock system of the vehicle body by the sending end;
verifying the unlocking instruction by the vehicle door lock system of the vehicle body;
based on a determination that the verification is correct, unlocking the vehicle body by the vehicle door lock system of the vehicle body; and
based on a determination that the verification is erroneous, not unlocking the vehicle body by the vehicle door lock system of the vehicle body.

6. A system for unlocking a vehicle, comprising:
a sending end, configured to send an unlocking instruction to unlock a vehicle body, wherein the sending end is electrically conducted to a human body, and wherein based on the contact between the human body and the vehicle body, a connection is established between the sending end and the vehicle body through the human body.

7. The system of claim 6, wherein the contact between the human body and the vehicle body is the contact between the hand of the human body and the door handle of the vehicle body.

8. The system of claim 6, wherein the connection between the sending end and the vehicle body is established through the human body by:
providing a human body coupling module in the sending end and the vehicle body respectively, wherein when the human body is in contact with the vehicle body, the human body coupling module is provided in the sending end, and the human body coupling module provided in the vehicle body is conducted through an electrical signal of the human body.

9. The system of claim 8, wherein the human body coupling module of the vehicle body comprises:
an authentication module, configured to perform authentication judgment on the human body coupling module of the sending end before the connection is established between the sending end and the vehicle body.

10. The system of claim 6, wherein the vehicle body comprises:
a receiving end configured to receive the unlocking instruction from the sending end; and
a verifying module configured to verify the unlocking instruction, wherein:
based on a determination that the verification is correct, a vehicle door lock system of the vehicle body will unlock the vehicle body; and
based on a determination that the verification is erroneous, the vehicle door lock system of the vehicle body will not unlock the vehicle body.

11. A system for unlocking a vehicle, arranged in a vehicle body of the vehicle, the system comprising:
a connection controlling unit, configured to establish a connection between the vehicle body and an external equipment electrically conducted to a human body, wherein the human body is in contact with the vehicle body;
a receiving unit, configured to receive an unlocking instruction sent from the external equipment;
a human body coupling module, configured to be conducted to a human body coupling unit of the external equipment through electrical signals of the human body; and
a vehicle door lock system, configured to control the unlocking of the vehicle body.

12. The system of claim 11, wherein the vehicle body further comprises:
a verifying module, configured to verify the unlocking instruction, wherein:
based on a determination that the verification is correct, the vehicle door lock system will unlock the vehicle body; and
based on a determination that the verification is erroneous, the vehicle door lock system will not unlock the vehicle body.

13. The system of claim 11, wherein the human body coupling module further comprises:
an authentication module, configured to perform authentication judgment on the human body coupling module of the external equipment before the connection is established between the external equipment and the vehicle body by the connection controlling unit.

14. The system of claim 11, wherein the vehicle body further comprises a door handle, and the contact between the human body and the vehicle body is the contact between the hand of the human body and the door handle of the vehicle body.

15. The system of claim 11, wherein the human body coupling module comprises a reception modulation circuit connected with a conductor, and the conductor is configured to be in contact with the skin of the human body and detect signals transmitted through the human body.
